(19) United States
(12) Patent Application Publication
(10) Pub. No.: US 2025/0369552 A1
(43) Pub. Date: Dec. 4, 2025

(54) PACKER FOR PIPE AND SEWER REHABILITATION

(71) Applicant: Pro-Kanal GmbH, Fürth (DE)

(72) Inventor: Dieter MEIER, Fürth (DE)

(21) Appl. No.: 19/223,520

(22) Filed: May 30, 2025

(30) Foreign Application Priority Data
Jun. 4, 2024 (DE) 10 2024 115 562.0

(51) Int. Cl. F16L 55/165; E03F 3/06; F16L 55/134; F16L 101/18; F16L 101/30

(52) U.S. Cl. CPC F16L 55/1654; E03F 3/06; F16L 55/134; E03F 2003/065; F16L 2101/18; F16L 2101/30

(57) ABSTRACT

A packer for pipe and sewer rehabilitation, having a front and a rear flange, between which an expandable sleeve which can be filled with a pressure medium and a stabilization arrangement which runs within the sleeve between the front and the rear flange are arranged, wherein the stabilization arrangement has:
a stabilization portion which has a first flexibility and covers the greater part of the total length between the flanges and directly adjoins the rear flange, and
a steering portion which extends from the stabilization portion to the front flange, wherein the steering portion has a second, greater flexibility than the stabilization portion.

### CROSS-REFERENCE TO RELATED APPLICATIONS

The present application claims priority of DE 10 2024 115 562.0, filed Jun. 4, 2024, the priority of this application is hereby claimed, and this application is incorporated herein by reference.

### BACKGROUND OF THE INVENTION

The invention relates to a packer for pipe and sewer rehabilitation, having a front and a rear flange, between which an expandable sleeve which can be filled with a pressure medium and a stabilization arrangement which runs within the sleeve between the front and the rear flange are arranged.

Packers for rehabilitating pipelines and sewers (often also referred to as “rehabilitation packers”) are already known in the prior art and consist mostly of an expandable sleeve which is closed at both ends. A connection for air or water as pressure medium is usually provided on a rear side, wherein pulling eyes may be used, for example on both sides, for movement purposes. A laminate/liner is wrapped around the packer and the packer is introduced into the line to be rehabilitated. The laminate usually consists of a glass fiber fabric or a glass fiber mat, said fabric or mat having been impregnated with a synthetic resin. Once the packer, together with the laminate, has been introduced to the area to be rehabilitated in the sewer or the pipeline, it is filled with the pressure medium, whereby it expands and presses the laminate against the damaged: area of the pipe wall. After the curing, the pressure medium is discharged and the packer is pulled out again, for example by means of the pulling eye. For positioning purposes, two-sided access is often utilized here.

In order to identify damage in sewers and pipes, it is known to introduce cameras into the corresponding pipe or the corresponding sewer in order to be able to identify in particular the position of the damage too. The type of damage and the exact position of the damage are recorded here. Therefore, for precise positioning of the rehabilitation packer, the measurements for reaching the position of damage can be transmitted to the corresponding positioning arrangement, for example comprising the pulling rope and/or a sliding device, by marking. The packer is only then fitted with laminate and pulled or pushed to the area of damage. This process is also usually monitored by a camera. After the laminate has cured, the camera is used again to record the result. The preliminary and subsequent work can take up a large portion, for example up to 50%, of the work time in a rehabilitation operation.

Therefore, the prior art has already proposed providing cameras on the rehabilitation packer itself. These cameras may, for example, extend the length of the packer on the outside of the front flange. DE 10 2022 104 411 A1 discloses a rehabilitation packer in which the rear and the front flange have leadthrough openings connected by a hollow leadthrough element within the sleeve, in a manner sealed off with respect to it, and through which a feed line is guided to a camera arrangement arranged adjoining the leadthrough opening in the front flange and having a camera. Therefore, this document: proposes attaching a camera, which runs in front of the front flange, to the packer, the camera allowing the movement travel of the packer to be monitored and in particular also the correct area intended to be rehabilitated to be located and the packer to be positioned more effectively. The leadthrough element can also have a stabilizing effect.

In particular, the stiffness of the hollow leadthrough element can be selected such that the spacing between the two flanges during movement and/or filling with the pressure medium remains at least substantially constant. In the case of leadthrough elements having such a stabilizing effect, the problem can additionally occur that, in particular in the case of sharp bends such as 90° bends, the packer cannot be guided around bends in spite of having a certain degree of bending flexibility.

In order to be able to rehabilitate pipelines and sewer lines which have bends, packers of which the shape can be adjusted using special devices have also been proposed. For example, DE 10 2008 021 956 A1 has proposed deforming the entire packer by means of an inner core. However, these packers are relatively difficult to handle and matching the bending of the packer to the actual pipe geometry is challenging.

### SUMMARY OF THE INVENTION

The object on which the invention is based is to specify a packer which can be navigated through a pipe or a sewer in an improved manner.

In order to achieve this object, according to the invention, provision is made in the case of a packer of the type mentioned in the introduction for the, in particular centrally running, stabilization arrangement to have:
a stabilization portion which has a first flexibility and covers the greater part of the total length between the flanges and directly adjoins the rear flange, and
a steering portion which extends from the stabilization portion to the front flange, wherein the steering portion has a second, greater flexibility than the stabilization portion.

Here, the (bending) flexibility relates to bending out of the longitudinal direction of the packer which is defined in the extended state of the packer from flange to flange. In this respect, the first and the second flexibility relate to force components perpendicular to the longitudinal direction, therefore transverse forces. In other words, the steering portion is more flexible or flexurally softer than the stability portion or the stability portion is flexurally harder than the steering portion. Specifically, the greater flexibility of the steering portion can be understood, for example, such that the flexural stiffness of the stability portion is greater than the flexural stiffness of the steering portion and/or the modulus of elasticity of the steering portion is greater than the modulus of elasticity of the stability portion.

Whereas the first flexibility would not be sufficient to achieve deformation of the packer, specifically deflection, in a transverse force region, in particular comprising transverse forces usually occurring within pipes and sewers during bending, this is not the case for the second flexibility, where the deflection results. Specifically, the flexibility of the steering portion can be, for example, 120 to 200%, preferably 130 to 180%, of the flexibility of the stability portion.

However, both the steering portion and the stabilization portion are sufficiently flexible for the packer to be able to be pushed through bends in the pipe or sewer, in particular bends of up to at least 90°, in particular even up to 180°. Here, the steering portion arranged on the front side acts as a navigation element which, owing to its greater flexibility or flexural softness, can be adapted more easily to bends in the course of the pipe or sewer and therefore specifies the further direction for the rest of the packer body. In particular, a sufficient transverse force effect is also achieved in the stability portion owing to support in the bending region and, in steps, also bending to be passed on to the stability portion, so that the stability portion also bends despite its greater flexural hardness (lower bending flexibility) and the packer follows the course of the pipe or sewer overall. However, at the same time, sufficient overall stability of the packer is further provided by the stabilization portion, for example during insertion. For this purpose, the stabilization portion is longer than the steering portion.

It is sufficient here to provide only a small proportion of the stabilization arrangement for the steering portion, so that, for example, provision can be made for the steering portion to comprise 1 to 20%, in particular 5 to 10%, of the total length between the flanges. It has been found here that the packer can still remain at least substantially inherently stable for transportation and introduction. Owing to the greater flexural stiffness in the rear stability portion, “kinking” or comparable compression of the packer is additionally reliably avoided, it being possible for this to be further improved by stabilization elements, which prevent longitudinal compression. This also creates a kind of “front drive effect” since the forward motion exerted on the rear flange reaches the front region of the packer as completely as possible. This effect is improved when stabilization elements of the steering portion also provide at least a predetermined longitudinal stiffness, which prevents compression in the steering portion too.

The ability of the packer to bend in the steering portion and/or in the stabilization portion is particularly advantageously at least partially elastic, so that in the event of bending, a restoring force for extending the packer in the longitudinal direction is produced and thus an at least substantially straight basic position is defined.

It can be said that the steering portion, as it were, replaces an additional navigation element adjoining the outside and front of the front flange. The integration proposed here of the navigation option into the packer itself advantageously results in a more compact, robust design. Furthermore, the ability to pass through bends is improved: since the support surface being situated further on the outside results in an improved steering effect of the flexurally harder part.

At least the front flange preferably has a convexly curved guide surface at least at the edge. In this way, the packer head can follow the course of the pipe or sewer in an improved manner and introduction of a bend in the steering portion is possible in an improved manner. An area of action for creating the transverse forces created by contact with the wall is provided.

In a particularly preferred development of the invention, the packer can further comprise a camera arrangement which is integrated into the front flange and has a camera directed at the area in front of the packer, wherein at least one cable connection to the camera arrangement is guided from the rear flange to the camera arrangement through the stabilization arrangement.

A further high level of integration is achieved in this way. The viewing direction of the camera is clearly defined and the camera is installed into the front flange in a protected manner. For this purpose, the front flange can have a, for example cylindrical, passage opening into which the, in particular likewise cylindrical, camera arrangement with the camera can be pushed and can be fastened there, in particular in a sealing manner. The fastening can be performed by screws, adhesive, clamping and/or similar fastening means. The camera can preferably be a wide-angle camera. Furthermore, the camera arrangement can also comprise at least one light source for illuminating the area in front of the packer.

In this way, the rehabilitation packer and the camera arrangement are merged to form one unit. The camera arrangement and the packer end closure, comprising the front flange, are thus highly integrated. The advantages of using a camera on the packer are combined with a simple, robust design. Owing to the steering portion, the camera is always oriented in the direction along the pipe or sewer without further operator actions being required.

The camera arrangement and at least one, in particular all, of the stabilization elements of the steering portion can particularly advantageously form a jointly installed steering unit. In particular, expansion arrangements fitted to the outside of the front flange up until now, and in particular comprising navigation elements that have been external up until now and the camera arrangement, can thus be reused with corresponding modifications since they already have the required flexibility. However, instead of expanding the packer body, integration into the packer itself is performed by way of the stabilization portion being shortened and connected to the stabilization elements of the steering portion within the sleeve. A conventional stabilization unit which forms the stabilization portion can then, in particular directly, adjoin the steering unit at the rear, it being possible for the stabilization unit to be connected for example by adhesive bonding and/or screwing and/or by connection of a feed line portion of the cable connection, to the camera arrangement, to the steering unit.

The at least one cable connection can expediently be guided through the stabilization arrangement within a pipe eel and/or a fiberglass rod, in particular which limits the longitudinal extent of the packer. The use of a flexible fiberglass rod is particularly preferred here since this substantially cannot be compressed or extended longitudinally and thus the spacing between the two flanges during movement and/or filling with the pressure medium remains at least substantially constant owing to the fiberglass rod, this also being preferred in general. The fiberglass rod, which extends between the flanges or at least between the rear flange and a connection of the steering unit, is preferably more flexible in terms of bending than the steering portion itself, that is to say does not define its flexural stiffness. Other stabilization elements, for example another pipe eel, which guide cable connections, are also preferably designed in such a way that they serve as part of a longitudinal limiting device which limits the longitudinal extent of the packer.

In a particularly preferred development, provision can further be made in this context for at least one stabilization element of the steering portion to have a longitudinal limiting effect on the steering portion. For example, the or a stabilization element providing the greater flexibility can be a tightly wound tension spring which as a result prevents further compression and a high force counteracts excessive extension but nevertheless provides the required reduced flexural stiffness. However, the or a stabilization element of the steering portion that provides the longitudinal limiting effect can also be a non-compressible but flexible hose (longitudinal limiting hose), in particular which surrounds the spring.

If the cable connection is provided in a fiberglass rod (or some other stabilization element which guides the cable connections in the stabilization portion) which is connected to a connection of the steering unit, provision may particularly advantageously be made for the steering unit to have a longitudinal limiting element, preferably guided within the tension spring, for example a steel cable. The longitudinal limiting element in the form of a stabilization element, which has a longitudinal limiting effect on the steering portion, can then have a dual function. Firstly, it prevents overextension of the cables guided from the connection of the steering unit to the camera arrangement, and secondly it advantageously limits the longitudinal extension.

The longitudinal limiting element is advantageously connected to the stabilization element guiding the cable connections in the stabilization portion, in particular the fiberglass rod, via the connection, so that the longitudinal limiting element and the guide element guiding the cable connections in the stabilization portion as a further longitudinal limiting element combine overall to form the longitudinal limiting device for the packer. Advantageously, no additional, further longitudinal limiting element, for example a core extending between the flanges over the entire length of the packer, is then required. The longitudinal limiting element may already be provided in any case for protecting the cable from the connection to the camera arrangement and supplied for a further purpose. In this context, the connection of the steering unit is preferably designed in such a way that the stabilization element guiding the cable connections through the stabilization portion is not released by being pulled, but rather is for example locked in place or fastened in some other interlocking manner.

Therefore, in general, it can be said that the steering portion can have, as stabilization elements providing the flexibility, a spring and/or a hose, in particular surrounding the spring. Here, a tension spring may already be sufficient, in particular when the stabilization arrangement is not sealed off from the rest of the interior of the sleeve, this being discussed in more detail below.

The stabilization portion can preferably comprise a leadthrough element, in particular a hose. The leadthrough element, for example in the form of a hose or comprising a hose, expediently provides enough stiffness to define the first flexibility and to provide the packer with sufficient mechanical stability. Sealing off is not required here, in particular since owing to the front flange nothing has to be passed to the outside, as would be the case for example with a camera arrangement arranged running in front. In particular, the interior of the packer can be closed off at the front by the front flange, possibly together with the camera arrangement integrated therein.

At least one UV light source of a curing device can preferably be arranged on the leadthrough element, the UV light source being operable via a cable connection within the leadthrough element. If the sleeve of the packer is transparent, light sources, in particular UV LEDs, which enable rapid curing by UV rays, may be fitted within the packer. UV light sources of this kind and possibly further associated means can lead to further flexural stiffness and longitudinal stiffness of the stabilization portion. In a certain sense, it can be said that this is at least partially compensated for by the more flexible steering portion.

It is particularly preferred for the sleeve of the packer, which may also be referred to as an inflation hose, to consist of a fabric-free material. As an alternative, the sleeve may also be entirely or partially reinforced with fabric, depending on the material and embodiment.

The rear flange can have a pressure medium connection for the pressure medium, as is known in principle. However, since, as has already been explained, sealing off of the interior of the stabilization arrangement, for example of a leadthrough element, is not necessary in the case of the configuration according to the invention, it is particularly advantageous when the pressure medium connection opens into the interior of the stabilization portion, which is not designed to provide sealing with respect to the rest of the interior of the sleeve. The pressure medium, for example water or a gas, therefore initially flows, in particular centrally, into the stabilization arrangement, for example the leadthrough element. From there, it can pass to the outside and fill and expand the sleeve. Therefore, connections on the outside can be avoided.

It is particularly advantageous when the rear flange has an, in particular central, connection device with the pressure medium connection and connections for the at least one cable connection for the camera and/or the at least one UV light source.

Therefore, it is possible in this way to provide all of the necessary connections on the rear flange via a central connection device together as a common connection. Dedicated partial connections for UV light, the camera arrangement and in particular pressure medium can be dispensed with. The pressure medium can flow into the: stabilization arrangement, in particular into the leadthrough element, in particular around the connected lines for the UV light and the camera arrangement. Since the interior of the stabilization arrangement is not sealed off with respect to the rest of the interior of the sleeve, it can inflate the sleeve from there. The overall design and establishment of the necessary connections are simplified and the robustness of the packer is increased.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawings:

FIG. 1 shows a basic overall cross-sectional view of an exemplary embodiment of a rehabilitation packer according to the invention,

FIG. 2 shows a partial view of a detail of the front region of the packer, and

FIG. 3 shows a partial view of a detail of the rear region of the packer.

### DETAILED DESCRIPTION OF THE INVENTION

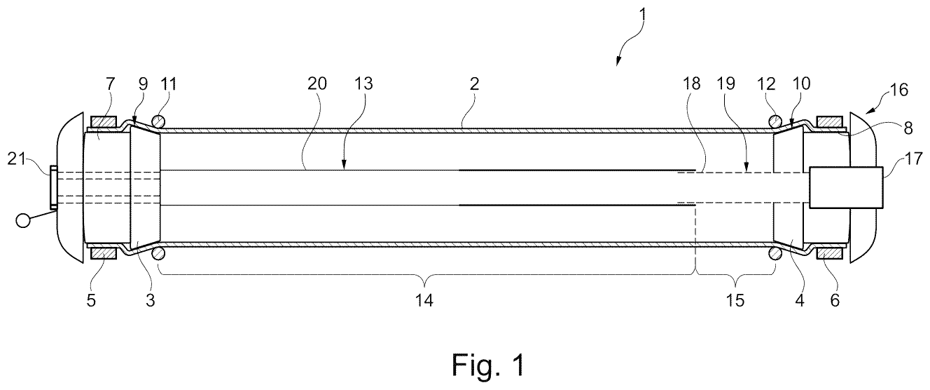

FIG. 1 shows a packer 1 according to the invention for pipe and sewer rehabilitation. The packer 1 comprises a sleeve 2 in the form of an inflation hose which serves as an outer shell and which is of hose-like design and consists of an expandable fabric-free or at least partially fabric-reinforced, transparent material. A flange 3, 4 is arranged at each of the two end portions of the sleeve 2, the sleeve 2 being firmly connected to the flanges 3, 4 by means of clamping rings 5, 6. The flanges 3, 4 each have an encircling groove in order to prevent the sleeve 2 from slipping, and also, on their inner side, a conical portion 9, 10 against which the sleeve 2 bears. A respective retaining ring or clamp 11, 12 is fitted on the outer side at this location.

In addition to the sleeve 2, a stabilization arrangement 13, indicated merely schematically in FIG. 1, extends between the flanges 3, 4, the stabilization arrangement comprising a stabilization portion 14 and a steering portion 15. The steering portion 15 is shorter than the stabilization portion and additionally has a greater flexibility, that is to say in particular a lower flexural stiffness and/or a higher modulus of elasticity, than the stabilization portion. The front flange 4 runs at the front in a region for forming a convex guide surface 16. As a result, when navigating through a pipe or sewer, it is easy for the packer head to follow the profile, even at bends, the transverse forces being sufficient to cause a suitable bend in the steering portion 15, the bend also continuing to the flexurally harder stabilization portion 14 with further propulsion.

A camera arrangement 17 with a camera is integrated into the front flange 4, directed onto the area in front of the packer 1 and designed as a wide-angle camera. The camera arrangement is fastened in a passage opening in the front flange 4. It forms a steering unit 19 with stabilization elements 18 of the steering portion 15, the steering unit being connected to the stabilization portion 14, specifically to a leadthrough element 20 as a stabilization element of the stabilization portion 14.

A central connection device 21 is provided on the rear flange 3. In the present case, the connection device comprises the connections for the pressure medium, the camera arrangement and UV light sources provided on the outside of the leadthrough element. Here, the pressure medium can flow around the cable connections for the UV light sources and the camera and fill the interior of the sleeve 2 through the non-sealing leadthrough element for these cable connections in order to inflate the sleeve and to press a laminate against a wall to be rehabilitated. The laminate can be cured by means of the UV light sources through the transparent sleeve 2.

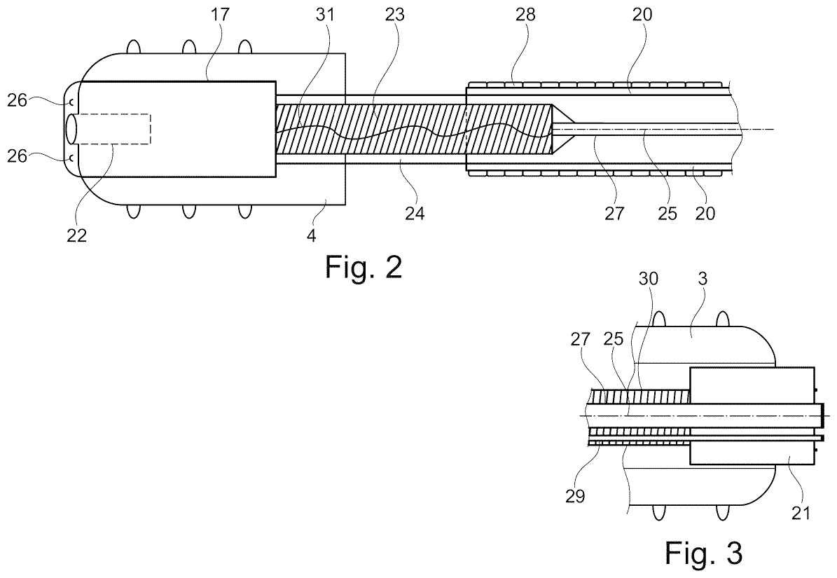

In this respect, FIG. 2 shows the front region of the packer 1 more precisely, but with the sleeve 2 not shown and the front flange 4 being drawn in abstract form for better illustration.

In the exemplary embodiment, two stabilization elements 18 of the steering portion 15, specifically a tension spring 23 and an optional hose 24, adjoin the camera arrangement 17 with the camera 22 in the steering unit 19. The tension spring 23 provides the second, greater bending flexibility of the steering portion 15. It is preferably tightly wound in order to also provide longitudinal compression limiting, in particular to avoid compression. In addition or as an alternative, the hose 24 can also have a compression limiting effect. In the present case, the hose 24 also serves for connection to the leadthrough element 20, which is likewise in the form of a hose. The UV light sources 28 are arranged on the outside of the leadthrough element 20. The cable connection 25 to the camera arrangement 17, comprising for example a power supply line for the camera 22 and in addition light sources 26, which form part of the camera arrangement 17, for illuminating the area in front of the camera 22 and also data lines, are guided through the leadthrough element 20 in a fiberglass rod 27.

The fiberglass rod 27, which is flexible but is not compressible, also serves as a length limiting element. It extends between a connection of the steering unit 19 which can lie within the tension spring 23. As an alternative or in addition, the leadthrough element 20 in the form of a longitudinal limiting hose can also have a longitudinal limiting effect. In the present case, the longitudinal limiting device can be completed by a longitudinal limiting element 31 of the steering unit 19 which-like the cable from the connection to the camera arrangement 17-extends within the tension spring 23 from the connection to the camera arrangement 17 and in the present case is in the form of a steel cable which is shorter than the cable. It therefore prevents overextension of the cable and at the same time acts jointly with the fiberglass rod 27 in a longitudinal extent limiting manner for the entire packer 1.

Owing to the integration of the camera arrangement 17 into the front flange 4, the rehabilitation packer 1 and the camera 22 are merged to form one unit. The steering portion 15 allows convenient and sufficiently easy navigation and always ensures correct orientation of the camera 22. As a result of the packer not being compressible in spite of the two portions 14, 15, no compression occurs at a pipe bend and a “front drive effect” is produced, which further makes it considerably easier for the packer fitted with the laminate to be pushed through.

The cable connection 25 is guided through the leadthrough element 20 as far as the connection device 21 on the rear flange 3, as shown by FIG. 3. This figure also shows how a common connection for the cable connection 25, the cable connection 29 to the UV light sources 28 and the pressure medium (see line 30 with an opening into the leadthrough element 20) is created. Connection of the packer 1 is possible by a single plug-in connection. In alternative exemplary embodiments, several plug-in connections can also be provided, for example separately for electricity and pressure medium.

In conclusion, it should be noted that, in particular for fastening purposes, the stabilization arrangement 13 or its stabilization elements 18, 20 can also project into other portions 14, 15 or the flanges 3, 4.

While specific embodiments of the invention have been shown and described in detail to illustrate the inventive principles, it will be understood that the invention may be embodied otherwise without departing from such principles.

I claim:

1. A packer for pipe and sewer rehabilitation, having a front and a rear flange, between which an expandable sleeve which can be filled with a pressure medium and a stabilization arrangement which runs within the sleeve between the front and the rear flange are arranged,
characterized in that the stabilization arrangement has:
a stabilization portion which has a first flexibility and covers the greater part of the total length between the flanges and directly adjoins the rear flange, and
a steering portion which extends from the stabilization portion to the front flange, wherein the steering portion has a second, greater flexibility than the stabilization portion.

2. The packer according to claim 1, wherein the steering portion comprises 1 to 20%, in particular 5 to 10%, of the total length between the flanges, and/or in that at least the front flange has a convexly curved guide surface at least at the edge.

3. The packer according to claim 1, wherein it further comprises a camera arrangement which is integrated into the front flange and has a camera directed at the area in front of the packer, wherein at least one cable connection to the camera arrangement is guided from the rear flange to the camera arrangement through the stabilization arrangement.

4. The packer according to claim 3, wherein the camera arrangement and at least one, in particular all, of the stabilization elements of the steering portion forms/form a jointly installed steering unit.

5. The packer according to claim 3, wherein at least one stabilization element of the steering portion has a longitudinal limiting effect on the steering portion.

6. The packer according to claim 1, wherein the stabilization portion comprises a leadthrough element.

7. The packer according to claim 6, wherein a UV light source of a curing device is arranged on the leadthrough element, the UV light source being operable via a cable connection within the leadthrough element.

8. The packer according to claim 1, wherein the rear flange has a pressure medium connection for the pressure medium.

9. The packer according to claim 8, wherein the pressure medium connection opens into the interior of the stabilization portion, which is not designed to provide sealing with respect to the rest of the interior of the sleeve.

10. The packer according to claim 9, wherein the rear flange has a connection device with the pressure medium connection and connections for the at least one cable connection for the camera and/or the at least one UV light source.
